(19) United States
(12) Patent Application Publication
(10) Pub. No.: US 2023/0343212 A1
(43) Pub. Date: Oct. 26, 2023

(54) METHOD FOR CALIBRATING A TRAFFIC MANAGEMENT SYSTEM, AND TRAFFIC MANAGEMENT SYSTEM

(71) Applicant: Continental Automotive Technologies GmbH, Hannover (DE)

(72) Inventors: Patrick Keck, Darmstadt (DE); Klaus Rink, Rodenbach (DE)

(73) Assignee: Continental Automotive Technologies GmbH, Hannover (DE)

(21) Appl. No.: 18/306,613

(22) Filed: Apr. 25, 2023

(30) Foreign Application Priority Data
Apr. 25, 2022 (DE) 10 2022 203 992.0

(51) Int. Cl. G08G 1/09; G08G 1/01

(52) U.S. Cl. CPC G08G 1/092; G08G 1/0141

(57) ABSTRACT

The embodiment relates to a method for calibrating a traffic management system which is configured for the automated guiding of a vehicle within a traffic region, which method is configured for the automated parking of a vehicle, and to such a traffic management system. The traffic management system comprises at least one monitoring sensor for monitoring the traffic region, a communication device for communication with a vehicle, in particular for sending driving directions to the vehicle, and a controller for processing the signals from the at least one monitoring sensor and for determining driving instructions for the vehicle. The method comprises the following steps:
detecting at least one object in the traffic region with the at least one monitoring sensor and storing the information about the object,
querying sensor information of at least one environmental sensor of the vehicle and checking whether the detected object is detected by the environmental sensor,
if the object is detected by the environmental sensor, retrieving the information of the environmental sensor relating to that object, and
calibrating the monitoring sensor taking account of the information about the object acquired by the monitoring sensor and the information about the object acquired by the environmental sensor of the vehicle.

### CROSS-REFERENCE TO RELATED APPLICATIONS

The present application claims priority from German Patent Application No. 10 2022 203 992.0 filed on Apr. 25, 2022, in the German Patent and Trade Mark Office, the disclosure of which is herein incorporated by reference in its entirety.

### BACKGROUND

### 1. Field

Embodiments of the present application relate to a method for calibrating a traffic management system which is configured for the automated guiding of a vehicle within a traffic region, in particular within a parking system which is configured for the automated parking of a vehicle, wherein the traffic management system comprises at least one monitoring sensor for monitoring the traffic region, a communication device for communication with a vehicle, in particular for sending driving directions to the vehicle, and a controller for processing the signals of the at least one monitoring sensor and for determining driving directions for the vehicle. Embodiments of the present application further relate to such a traffic management system.

### 2. Description of Related Art

Traffic management systems are known from the prior art which assume control of a vehicle within a traffic region and guide the vehicle in an automated manner within the traffic region. Guiding here includes the sending of driving directions which are implemented by the vehicle, in particular in an automated manner. Such traffic management systems are used, for example, for automated parking systems, in which the vehicle is given over to the parking system and is driven thereby in a remotely controlled manner to a parking place within the parking system.

The traffic area is here monitored by means of monitoring sensors of the traffic management system. The monitoring sensors are, for example, cameras which make it possible to optically detect the traffic area and all objects within the traffic area. The traffic management system has a controller in which a map of the traffic area is stored. In dependence on the information from the monitoring sensors and the stored map of the traffic area, the controller is able to calculate a route for the vehicle within the traffic area and send corresponding driving directions to the vehicle by way of a communication device. The vehicle is able to implement these driving directions and, controlled by the driving directions, is able to follow the route calculated by the controller. The vehicle is monitored within the traffic area by the monitoring sensors, in particular while it is driving, so that the route or the driving directions can be corrected while the vehicle is driving, for example if it deviates from the calculated route or if obstacles or hazards occur on the calculated route.

The monitoring sensors must have high accuracy in order that they can detect the vehicle position and the vehicle orientation within the traffic area as exactly as possible and calculate the driving directions therefrom. However, during normal operation of such a traffic management system, faults or changes in the monitoring sensors can occur. For example, the orientation or the position of a monitoring sensor can be changed, for example as a result of an impact, a collision or incorrect mounting. A change in the position and/or orientation can, however, have the result that the position and orientation of a vehicle relative to other objects within the traffic area, for example other vehicles or fixed objects, cannot be determined with sufficient accuracy.

### SUMMARY

According to an aspect of the present application, there is provided a method which makes possible to check and calibrate the traffic management system, in particular the monitoring sensors. In particular, it is to be possible to carry out the checking and calibration during normal operation of the traffic management system. It is also an aspect of the present application to provide a traffic management system which makes possible to check and calibrate the traffic management system.

According to an aspect of an embodiment, there is provided a method for calibrating a traffic management system which is configured for the automated guiding of a vehicle within a traffic region, in particular within a parking system which is configured for the automated parking of a vehicle. The traffic management system comprises at least one monitoring sensor for monitoring the traffic region, a communication device for communication with a vehicle, in particular for sending driving directions to the vehicle, and a controller for processing the signals of the at least one monitoring sensor and for determining driving directions for the vehicle. The method includes detecting at least one object in the parking system with the at least one monitoring sensor and storing the information about the object, querying sensor information of at least one environmental sensor of the vehicle and checking whether the detected object is detected by the environmental sensor, if the object is detected by the environmental sensor, retrieving the information of the environmental sensor relating to that object, and calibrating the monitoring sensor taking account of the information about the object acquired by the monitoring sensor and the information about the object acquired by the environmental sensor of the vehicle.

In principle, monitoring of the traffic region is carried out solely by the monitoring sensors of the traffic management system. The idea underlying the embodiment is to use the environmental sensors of the vehicles within the traffic area to check the accuracy of the monitoring sensors and optionally to calibrate them. To that end, objects that can be detected both by the monitoring sensors and by the environmental sensors are defined. The position and/or orientation, detected by the environmental sensors of a vehicle, of such an object are compared with the information acquired by a monitoring sensor. If the pieces of information differ from one another, it must be assumed that the information from the monitoring sensor or the information from the environmental sensor is not correct. If the environmental sensor is working without problems and the position of the vehicle in the traffic region is correct, it must be assumed that the information from the monitoring sensor is incorrect. That information can then be corrected with the information from the environmental sensor, and thus the monitoring sensor can be calibrated.

For example, the position of the vehicle can be verified by further monitoring sensors and/or the vehicle can have a self-diagnosing function which checks the environmental sensors.

The traffic management system can thus be checked and calibrated easily by using the environmental sensors present in a large number of vehicles. No additional sensors within the traffic management system are required. In particular, the accuracy can be improved if the information from environmental sensors of multiple vehicles and/or the information about multiple different objects is used. For example, an object can be detected by multiple vehicles, so that the information from the environmental sensors of the vehicles can additionally be compared. In particular, the information from the environmental sensors and from the monitoring sensors relating to different objects can also be compared if the environmental sensors of a vehicle detect multiple objects.

Preferably, at least one object that can be detected by the at least one monitoring sensor is defined beforehand in the traffic region. For example, the object is a stationary object, in particular part of the building structure of the traffic region. The object can be, for example, a pillar, a wall or another structural component.

The information relating to the at least one object can be stored in the controller, wherein the calibration of the monitoring sensor is carried out taking account of the position and orientation of the object stored in the controller. For example, a map of the traffic region is recorded in the controller, in which map the position and orientation of the objects are stored. As a result, it is also possible, for example, to recognize whether an object is within the detection range of the environmental sensors of a vehicle, and the information about the object acquired by the environmental sensor of the vehicle can be compared with the information stored in the controller and/or acquired by the monitoring sensor.

The information about the object can include, for example, a position and/or an orientation within the traffic region.

If the objects are defined beforehand, objects that can be detected particularly easily by the monitoring sensors and the environmental sensors are preferably chosen. For example, there are chosen for this purpose structures or objects which have a shape that is clearly identifiable, for example with straight edges or corners which can be detected particularly easily with sensors. The objects can additionally be accentuated such that they can better be detected with the monitoring sensors and/or the environmental sensors. Such an accentuation can be effected, for example, by a structure, for example a surface structure, a shape, a particular material and/or a color design.

In addition, additional elements can be provided on the at least one object for better detection of the object with the monitoring sensor and/or the environmental sensor. For example, additional marking marks or structures or reflectors can be provided on the objects. Such markings make it possible to detect the position and orientation of an object particularly accurately. Reflectors can additionally improve the detectability of the object for the sensors. In particular, the objects can be accentuated such that the accentuation can be clearly associated with an object, so as to rule out confusion between the objects. In particular, the position of the objects can also be chosen such that they can be detected particularly easily both by the monitoring sensors and by the environmental sensors of the vehicles.

The accuracy of the environmental sensors of a vehicle can be dependent on the distance of the object from the vehicle. For example, the accuracy of the sensors can decrease as the distance of the vehicle from the object increases. For this reason, the distance of an object from the environmental sensor of the vehicle, for example, can additionally be checked. Calibration of the monitoring sensor can be carried out in dependence on the distance of the object from the environmental sensor. For example, calibration can be suspended if the accuracy of the information from the environmental sensor is not sufficient for calibration. If it is found that the environmental sensor can detect the object with very high accuracy, for example because the object is very close to the vehicle, the calibration can be carried out with greater accuracy. For example, the distance of the object from the vehicle can also be taken into account as information about the object for the calibration.

The quality of the detection of the objects with the monitoring sensors and/or the environmental sensors can also be dependent on external influences. For example, optical sensors frequently require sufficient lighting in order to be able to detect objects and structures with sufficient accuracy. Additional measures in the traffic area and/or of the vehicle can be initiated by the controller of the traffic management system, in order to enable the object to be better detected with the monitoring sensor and/or the environmental sensor. For example, lighting of the traffic region can be initiated by the controller. This lighting can be effected, for example, by means of stationary lighting installed in the traffic region. Optionally, the objects can also have lighting or illuminated markings which can be activated by the controller. The controller can, however, also send corresponding instructions to the vehicle, for example in order to switch on the vehicle lights. In particular, these measures are initiated in dependence on the information about the object acquired by the monitoring sensor and/or the information about the object acquired by the environmental sensor, for example if an analysis of the information about the object by the controller reveals that the accuracy of the information about the object is not sufficient to carry out a calibration.

There can be used as the environmental sensor all sensors in the vehicle which have sufficient accuracy. For example, at least one environmental sensor can be an ultrasonic sensor, an optical sensor or a RADAR sensor.

The monitoring sensors of the traffic region can likewise be sensors of any kind. Preferably, at least one monitoring sensor is an optical sensor, in particular a camera.

According to an aspect of an embodiment, there is furthermore provided a traffic management system which is configured for the automated guiding of a vehicle within a traffic region, in particular within a parking system which is configured for the automated parking of a vehicle. The traffic management system comprises at least one monitoring sensor for monitoring the traffic region, a communication device for communication with a vehicle, in particular for sending driving directions to the vehicle, and a controller for processing the signals of the at least one monitoring sensor and for determining driving directions for the vehicle. The traffic management system can be checked and calibrated by at least one of the methods described above.

### BRIEF DESCRIPTION OF THE DRAWINGS

Further advantages and features will become apparent from the following description in connection with the appended drawings. in which:

FIG. 1 shows a schematic illustration of a traffic management system according to an embodiment;

FIG. 2 is a flow diagram illustrating a method for checking and calibrating the traffic management system of FIG. 1; and

FIG. 3 is a flow diagram illustrating a method for checking and calibrating the traffic management system of FIG. 1.

### DETAILED DESCRIPTION

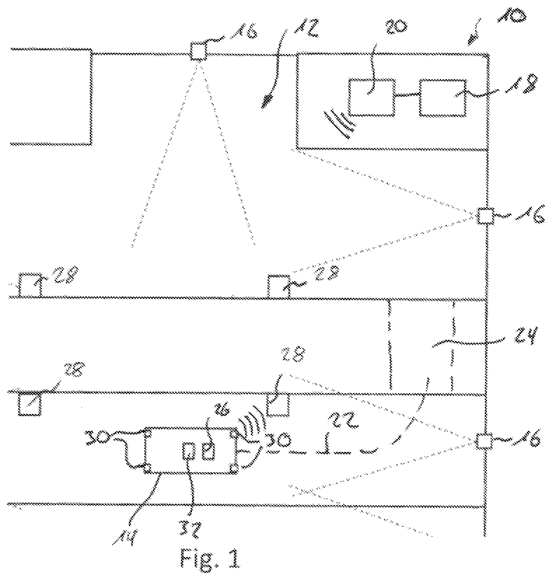

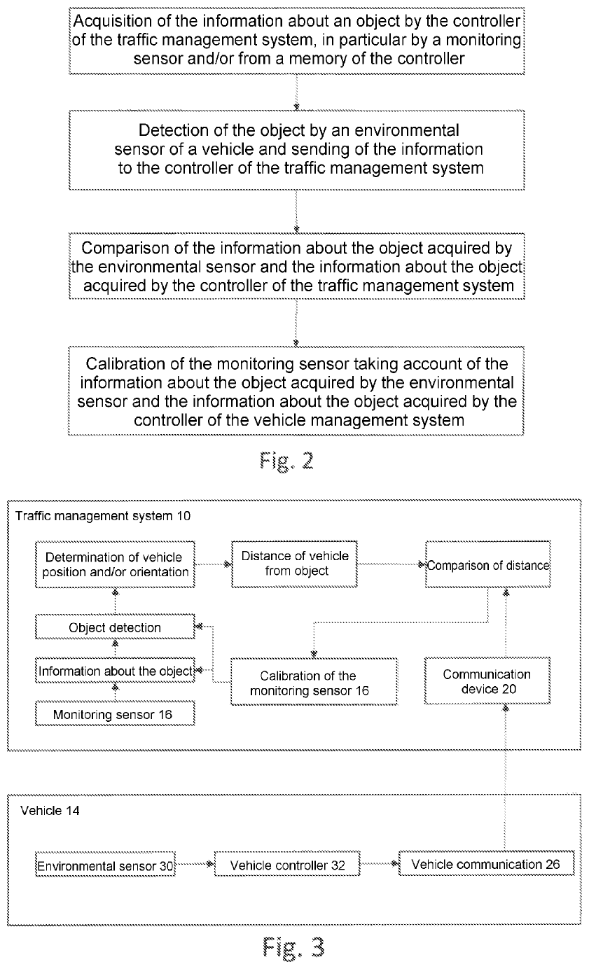

FIG. 1 shows a detail of a traffic management system 10, which in the embodiment shown here is a parking system. The traffic management system 10 has a traffic region 12 in which vehicles 14 are able to move. The vehicles 14 are guided within the traffic region 12 by the traffic management system 10.

The traffic management system 10 has multiple monitoring sensors 16 for monitoring the traffic region 12. The monitoring sensors 16 are, for example, optical sensors, in particular cameras, which each produce an image of a region of the traffic region 12. The monitoring sensors 16 are so arranged that the entire traffic region 12 can be monitored.

The traffic management system 10 further has a controller 18 which is connected to the monitoring sensors 16 and which is able to process the information from the monitoring sensors 16. A map of the traffic region 12, for example, is stored in the controller 18. The controller 18 is further connected to a communication device 20 which is able to establish communication with the vehicles 14 and send information to or receive information from the vehicle 14.

The monitoring sensors 16 of the traffic management system 10 detect the vehicles 14 which are within the traffic region 12. Preferably, the vehicles 14 must register beforehand and check in with the controller 18. The controller 18 determines a driving path 22 for the vehicles 14, for example to a parking space 24 for the vehicle 14. The communication device 20 then sends corresponding driving directions to the vehicle 14. The driving commands are received by a vehicle communication device 26. The vehicle 14 then drives independently or remotely controlled by the controller 18 along the driving path 22 to the parking space 24.

While the vehicle is driving within the traffic management system 10, the position, orientation and direction of movement of the vehicle 14 are monitored by the monitoring sensors 16. In addition, the traffic region 12 as a whole is monitored by the sensors. The driving directions can be adapted and sent to the vehicle while the vehicle 14 is driving, for example if the controller 18 detects that the vehicle 14 has deviated from the calculated driving path 22 or obstacles or hazards on the driving path are identified by the monitoring sensors.

Monitoring of the vehicle 14 must be carried out with very high accuracy in order to prevent collisions with other vehicles or other objects 28, for example pillars or walls. During normal operation, however, the orientation of a monitoring sensor 16 can change, whereby the accuracy of the monitoring sensor 16 decreases.

In order to check the traffic management system or the monitoring sensors 16, stationary objects 28 which can be detected by the monitoring sensors 16 are defined within the traffic region 12. The information about these objects is transmitted to or stored in the controller 18. The information can be, for example, a position or an orientation of the object 28. In addition, the objects 28 and information about that object 28 can be recorded in the map which is stored in the controller 18.

The vehicle 14 has environmental sensors 30 with which the environment of the vehicle 14 can be detected in normal vehicle operation. For example, the environmental sensors 30 are ultrasonic sensors of a parking aid. Alternatively, the environmental sensors 30 can also be optical sensors, RADAR or LIDAR sensors. The environmental sensors 30 are connected to a vehicle controller 32.

In order to check the monitoring sensors 16, the controller checks whether one of the objects 28 is within the detection range of an environmental sensor 30 of the vehicle 14. If that is the case, the information about the object 28 acquired by the environmental sensor 30 or processed by the vehicle controller 32 is retrieved from the vehicle controller 32. The vehicle controller 32 sends the information to the communication device 20 or the controller 18 by way of the vehicle communication device 26.

In the controller 18, the information about the object 28 acquired by the environmental sensor 30 is compared with the information about the object 28 stored in the controller or acquired by the monitoring sensors 16.

If these pieces of information are different, the reliability of the information from the vehicle 14 can additionally be checked, for example by checking the position of the vehicle by additional monitoring sensors 16. The monitoring sensor 16 can then be calibrated taking account of the information about the object 28 acquired with the environmental sensor 30.

Recognition of the objects 28 can additionally be improved by accentuating the objects 28 such that they can be detected more reliably and more accurately by the environmental sensor 30 and/or the monitoring sensor 16. For example, the objects 28 can have a particular structure or shape. The structure or shape can have, for example, special edges or surfaces which can be detected and allocated identified particularly easily by the environmental sensor 30 and/or the monitoring sensor 16. For example, the objects 28 can also have a defined surface structure, for example a three-dimensional structure, or can be painted a specific color or in a color pattern. In particular, the objects 28 can be clearly identified by their structure, that is to say the individual objects 28 each have an individual, distinctive structure.

In addition, further elements which permit better detection and identification of the object 28 can also be provided on the objects 28. For example, the object 28 can be provided with reflector elements which reflect signals of an active sensor system which has a signal transmitter and a signal receiver.

The elements can, for example, also be active elements, for example lighting which is activated by the controller 18 in order to improve detection of the objects 28.

Optionally, the controller can check whether the quality of the information acquired by the environmental sensor 30 and of the information about an object 28 acquired by the monitoring sensor 16 is sufficient to compare those pieces of information with one another and/or to carry out a calibration of the monitoring sensor 16. If the quality is not sufficient, additional measures can be initiated by the controller 18 in order to improve the detection of the object 28 with the environmental sensor 30 and/or the monitoring sensor 16. For example, additional lighting can be activated. The lighting can be, for example, stationary lighting of the traffic region 12. Optionally, the controller 18 can also send a corresponding instruction to the vehicle 14 to switch on the vehicle lighting of the vehicle 14. In particular, such lighting can effect better accentuation of edges or shapes of the object 28.

Furthermore, the distance of the vehicle 14 from the object 28 can additionally be detected. As a result, it can be checked, for example, whether the distance of the object 28 from the vehicle 14 is sufficient to acquire the information about the object 28 with sufficient accuracy. In particular, the information about the object acquired with the environmental sensor 30 can be weighted or taken into account in the calibration in dependence on the distance of the vehicle 14 from the object 28. In particular, the vehicle 14 can also have different environmental sensors 16, wherein the information from the environmental sensors 16 is taken into account or used in dependence on the distance from the object 28.

1. A method for calibrating a traffic management system which is configured for the automated guiding of a vehicle, the method comprising:
detecting at an object in a traffic region of the vehicle;
obtaining information relating to the object detected by an environmental sensor of the vehicle; and
calibrating a monitoring sensor of the vehicle for detecting the object based on information relating to the object acquired by the monitoring sensor and the information relating to the object acquired by the environmental sensor of the vehicle.

2. The method as claimed in claim 1, wherein the object is defined beforehand in the traffic region.

3. The method as claimed in claim 2, further comprising storing the information relating to the object.

4. The method as claimed in one claim 2, wherein the information relating the object comprises a position and an orientation of the object within the traffic region.

5. The method as claimed in claim 4, wherein the object is accentuated by a structure, shape, material or color.

6. The method as claimed in claim 5, wherein the object comprises reflector elements provided on the object.

7. The method as claimed in claim 6, further comprising determining a distance of the object from the environmental sensor of the vehicle,
wherein the calibrating comprises calibrating the monitoring sensor based on the distance of the object from the environmental sensor.

8. The method as claimed in claim 1, wherein the environmental sensor is an ultrasonic sensor, an optical sensor or a RADAR sensor.

9. The method as claimed in claim 8, wherein the monitoring sensor is an optical sensor.
